(19) United States
(12) Patent Application Publication
(10) Pub. No.: US 2026/0230200 A1
(43) Pub. Date: Aug. 6, 2026

(54) UPLINK TIMING ADVANCE LOOP MANAGEMENT

(71) Applicant: Nokia Technologies Oy, Espoo (FI)

(72) Inventors: Morten TOFT, Aalborg (DK); Christian ROM, Aalborg (DK); Samantha CAPORAL DEL BARRIO, Aalborg (DK)

(21) Appl. No.: 19/152,860

(22) PCT Filed: Feb. 15, 2024
(86) PCT No.: PCT/IB2024/051436

§ 371 Date: Jul. 31, 2025

(30) Foreign Application Priority Data
Feb. 17, 2023 (FI) 20235194

(51) Int. Cl. H04B 17/318; H04L 5/00

(52) U.S. Cl. CPC H04B 17/318; H04L 5/0044

(57) ABSTRACT

Aspects and embodiments relate to apparatus and methods for uplink timing advance loop management. One aspect provides user equipment comprising: means for indicating, to another node, that a plurality of timing advance loops are supported;
means for receiving, from the another node, a configuration for measuring received reference signals from the another node; means for performing measurements on the received reference signals according to the configuration; means for evaluating, based on the measurements, an indication of a predicted signal quality metric in relation to at least one of: the another node or a further node based upon conditional use of at least one timing advance loop; and means for transmitting information relating to the evaluated indication of a predicted signal quality metric in relation to the at least one of the another node or the further node.

### TECHNOLOGICAL FIELD

Various example embodiments relate to apparatus and methods for uplink timing advance loop management.

### BACKGROUND

Timing advance (TA) loops are implemented within network to enables user equipment to control and adjust uplink transmission timing to facilitate alignment of uplink signals at a receiving node. A TA command or value is sent to user equipment by a network to achieve uplink signal alignment. In a multiple transmission reception point (TRP) enabled network, user equipment may be able to connect to multiple transmission reception points (m-TRP). Some adaptation of timing advance approaches may be required to facilitate operation of user equipment in a m-TRP scenario.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments there is provided: an apparatus, comprising: means for indicating, to another node, that a plurality of timing advance loops are supported; means for receiving, from the another node, a configuration for measuring received reference signals from the another node; means for performing measurements on the received reference signals according to the configuration; means for evaluating, based on the measurements, an indication of a predicted signal quality metric in relation to at least one of: the another node or a further node based upon conditional use of at least one timing advance loop; and means for transmitting information relating to the evaluated indication of a predicted signal quality metric at the at least one of the another node and further node.

According to some embodiments, the apparatus comprises user equipment. According to some embodiments, the another node comprises a network node. According to some embodiments, the further node comprises a network node.

According to some embodiments, the another node and further node may comprise different physical nodes, for example different TRPs. Accordingly, embodiments may relate to, for example, two loops for supporting two Transmission Configuration Indicator States (TCIs) and those loops may each be associated with a different TRP. According to some embodiments, the another node and further node may comprise the same physical node, and the different “nodes” are represented by two TCIs of the same TRP. Accordingly, a node according to some embodiments may comprise a TCI beam of a TRP, and a different node may comprise a different TCI beam of the same TRP.

According to some embodiments, the received reference signals comprise downlink signals. According to some embodiments, the received reference signals comprise signals received from the another node and/or from the further node. According to some embodiments, the evaluated indication of a predicted signal quality metric comprises an evaluated indication of a predicted uplink signal quality metric.

According to embodiments, conditional use of a timing advance loop, or timing advance loops, refers to an apparatus making a tentative alignment assumption at another node or at a further node. Using that, an apparatus may test different timing alignments, e.g., as alignment targets a timing advance loop, when evaluating a predicted signal quality metric, or when deriving or transmitting related information to another node or to a further node, without actually performing timing alignment. Conditional use may be understood to mean hypothesized or tentatively assumed use of a loop.

According to some embodiments, the configuration for measuring received reference signals comprises: an indication of one or more signal quality metric to be evaluated.

According to some embodiments, the one or more signal quality metric to be evaluated comprises: an indication of interference, or an indication of signal spread, at the another node or further node as a result of conditional use of the at least one timing advance loop.

According to some embodiments, the one or more signal quality metric to be evaluated comprises: an indication of interference caused by timing misalignment caused at the another node or further node based upon conditional use of the at least one timing advance loop.

According to some embodiments, the configuration for measuring received reference signals comprises: a threshold predicted quality metric.

According to some embodiments, the apparatus comprises: comparison means for comparing the evaluated indication of predicted signal quality metric at the another node or further node against the threshold predicted quality metric.

According to some embodiments, the transmitted information relating to the evaluated indication of a predicted signal quality metric at the at least one of the another node and further node comprises: an indication of whether the predicted signal quality metric is above or below the threshold.

According to some embodiments, the apparatus comprises: receiving means for receiving an activation of an additional timing advance loop to be applied in relation to communication with the at least one of the another node and further node in response to transmitting information relating to the evaluated indication of a predicted signal quality metric at the at least one of the another node and further node.

According to some embodiments, the means comprise: at least one processor; and at least one memory including computer program code, the at least one memory and the computer program code configured to, with the at least one processor, cause the performance of the apparatus.

According to various, but not necessarily all, example embodiments there is provided a user equipment method, comprising: indicating, to another node, that a plurality of timing advance loops are supported; receiving, from the another node, a configuration for measuring received reference signals from the another node; performing measurements on the received reference signals according to the configuration; evaluating, based on the measurements, an indication of a predicted signal quality metric at in relation to at least one of: the another node or further node based upon use of a common timing advance loop; and transmitting, information relating to the evaluated indication of a predicted signal quality metric at the at least one of the another node and further node.

According to some embodiments, the another node comprises a network node. According to some embodiments, the further node comprises a network node. According to some embodiments, the received reference signals comprise downlink signals. According to some embodiments, the received reference signals comprise signals received from the another node and/or from the further node. According to some embodiments, the evaluated indication of a predicted signal quality metric comprises an evaluated indication of a predicted uplink signal quality metric.

According to some embodiments, the configuration for measuring received reference signals comprises: an indication of one or more signal quality metric to be evaluated.

According to some embodiments, the one or more signal quality metric to be evaluated comprises: an indication of interference, or an indication of signal spread, at the another node or further node as a result of conditional use of the at least one timing advance loop.

According to some embodiments, the one or more signal quality metric to be evaluated comprises: an indication of interference caused by timing misalignment caused at the another node or further node based upon conditional use of the at least one timing advance loop.

According to some embodiments, the configuration for measuring received reference signals comprises: a threshold predicted quality metric.

According to some embodiments, the method comprises: comparing the evaluated indication of predicted signal quality metric at the another node or further node against the threshold predicted quality metric.

According to some embodiments, the transmitted information relating to the evaluated indication of a predicted signal quality metric at the at least one of the another node and further node comprises: an indication of whether the predicted signal quality metric is above or below the threshold.

According to some embodiments, the method comprises: receiving an activation of an additional timing advance loop to be applied in relation to communication with the at least one of the another node and further node in response to transmitting information relating to the evaluated indication of a predicted signal quality metric at the at least one of the another node and further node.

According to various, but not necessarily all, example embodiments there is provided: a computer program product operable, when executed on a computer, to perform the method of: indicating, to another node, that a plurality of timing advance loops are supported; receiving, from the another node, a configuration for measuring received reference signals from the another node; performing measurements on the received reference signals according to the configuration;
evaluating, based on the measurements, an indication of a predicted signal quality metric at in relation to at least one of: the another node or further node based upon use of a common timing advance loop; and transmitting, information relating to the evaluated indication of a predicted signal quality metric at the at least one of the another node and further node.

A non-transitory computer-readable medium storing computer program code including instructions that, when executed by a processor, cause apparatus to perform the steps of: indicating, to another node, that a plurality of timing advance loops are supported; receiving, from the another node, a configuration for measuring received reference signals from the another node; performing measurements on the received reference signals according to the configuration;
evaluating, based on the measurements, an indication of a predicted signal quality metric at in relation to at least one of: the another node or further node based upon use of a common timing advance loop; and transmitting, information relating to the evaluated indication of a predicted signal quality metric at the at least one of the another node and further node.

According to various, but not necessarily all, example embodiments there is provided: an apparatus, comprising: means for determining that a plurality of timing advance loops are supported by a node; means for transmitting, to the node, a configuration for measuring received reference signals; means for receiving, from the node, information relating to an evaluated indication of a predicted signal quality metric at the least one of another node or a further node.

According to some embodiments, the apparatus comprises a network node. According to some embodiments, the node comprises user equipment. According to some embodiments, the further node comprises a network node. According to some embodiments, the received reference signals comprise downlink signals. According to some embodiments, the received reference signals comprise signals received at the user equipment from the another node and/or from the further node. According to some embodiments, the evaluated indication of a predicted signal quality metric comprises an evaluated indication of a predicted uplink signal quality metric.

According to some embodiments, the configuration for measuring received signals comprises: an indication of one or more signal quality metric to be evaluated.

According to some embodiments, the one or more signal quality metric to be evaluated comprises: an indication of interference, or an indication of signal spread at the at least one of the another node or further node as a result of conditional use of the at least one timing advance loop.

According to some embodiments, the configuration for measuring received reference signals comprises: a threshold predicted quality metric.

According to some embodiments, the apparatus comprises: determination means configured to compare the information relating to the evaluated indication of a predicted signal quality metric at the at least one of the another node and further node against a threshold predicted quality metric to determine whether to activate an additional timing advance loop.

According to some embodiments, the apparatus comprises: assessment means configured to assess the information relating to the evaluated indication of a predicted signal quality metric at the at least one of the another node and further node to assess whether the threshold predicted quality metric is met.

According to some embodiments, the apparatus comprises: means for transmitting an activation of at least one additional timing advance loop in response to the determination based upon the received evaluated indication of a predicted signal quality metric at the at least one of the another node and further node.

According to some embodiments, the means comprise: at least one processor; and at least one memory including computer program code, the at least one memory and the computer program code configured to, with the at least one processor, cause the performance of the apparatus.

According to various, but not necessarily all, example embodiments there is provided: a network node method, comprising: determining that a plurality of timing advance loops are supported by a node; transmitting, to the node, a configuration for measuring received reference signals; receiving, from the node, information relating to an evaluated indication of a predicted signal quality metric at the least one of another node or a further node.

According to come embodiments, the apparatus comprises a network node. According to some embodiments, the node comprises user equipment. According to some embodiments, the further node comprises a network node. According to some embodiments, the received reference signals comprise downlink signals. According to some embodiments, the received reference signals comprise signals received at the user equipment from the another node and/or from the further node. According to some embodiments, the evaluated indication of a predicted signal quality metric comprises an evaluated indication of a predicted uplink signal quality metric.

According to some embodiments, the configuration for measuring received signals comprises: an indication of one or more signal quality metric to be evaluated.

According to some embodiments, the one or more signal quality metric to be evaluated comprises: an indication of interference, or an indication of signal spread at the at least one of the another node or further node as a result of conditional use of the at least one timing advance loop.

According to some embodiments, the configuration for measuring received reference signals comprises: a threshold predicted quality metric.

According to some embodiments, the method comprises: comparing the information relating to the evaluated indication of a predicted signal quality metric at the at least one of the another node and further node against a threshold predicted quality metric to determine whether to activate an additional timing advance loop.

According to some embodiments, the method comprises: assessing the information relating to the evaluated indication of a predicted signal quality metric at the at least one of the another node and further node to assess whether the threshold predicted quality metric is met.

According to some embodiments, the method comprises: transmitting an activation of at least one additional timing advance loop in response to the determination based upon the received evaluated indication of a predicted signal quality metric at the at least one of the another node and further node.

According to various, but not necessarily all, example embodiments there is provided: a computer program product operable, when executed on a computer, to perform the method of: determining that a plurality of timing advance loops are supported by a node; transmitting, to the node, a configuration for measuring received reference signals; receiving, from the node, information relating to an evaluated indication of a predicted signal quality metric at the least one of another node or a further node.

A non-transitory computer-readable medium storing computer program code including instructions that, when executed by a processor, cause apparatus to perform the steps of: determining that a plurality of timing advance loops are supported by a node; transmitting, to the node, a configuration for measuring received reference signals; receiving, from the node, information relating to an evaluated indication of a predicted signal quality metric at the least one of another node or a further network node.

According to various, but not necessarily all, example embodiments there is provide: an apparatus, comprising: means for transmitting, to a network node, an indication that a plurality of timing advance loops are supported; means for receiving, from the network node, a configuration for measuring downlink reference signals; means for performing measurements on the downlink reference signals according to the configuration; means for evaluating, based on the measurements, an indication of a predicted uplink signal quality metric at a further network node based upon use of a common timing advance loop; and means for transmitting, to the network node, an indication of the evaluated indication of a predicted uplink signal quality metric at the further network node.

According to some example embodiments, the apparatus may comprise user equipment.

According to various, but not necessarily all, example embodiments there is provided: a user equipment method, comprising: transmitting, to a network node, an indication that a plurality of timing advance loops are supported; receiving, from the network node, a configuration for measuring downlink reference signals; performing measurements on the downlink reference signals according to the configuration; evaluating, based on the measurements, an indication of a predicted uplink signal quality metric at a further network node based upon use of a common timing advance loop; and transmitting, to the network node, an indication of the evaluated indication of a predicted uplink signal quality metric at the further network node.

According to various, but not necessarily all, example embodiments there is provided: an apparatus, comprising: means for receiving, from a user equipment, an indication that a plurality of timing advance loops are supported by the user equipment; means for transmitting, to the user equipment, a configuration for measuring downlink reference signals; means for receiving, from the user equipment, an evaluated indication of a predicted uplink signal quality metric at a further network node.

According to some example embodiments, the apparatus may comprise: a network node.

According to various, but not necessarily all, example embodiments there is provided: a network node method, comprising: receiving, from a user equipment, an indication that a plurality of timing advance loops are supported by the user equipment; transmitting, to the user equipment, a configuration for measuring downlink reference signals; receiving, from the user equipment, an evaluated indication of a predicted uplink signal quality metric at a further network node.

According to various, but not necessarily all, example embodiments there is provided: a computer program product operable, when executed on a computer, to perform the method of: transmitting, to a network node, an indication that a plurality of timing advance loops are supported; receiving, from the network node, a configuration for measuring downlink reference signals; performing measurements on the downlink reference signals according to the configuration; evaluating, based on the measurements, an indication of a predicted uplink signal quality metric at a further network node based upon use of a common timing advance loop; and transmitting, to the network node, an indication of the evaluated indication of a predicted uplink signal quality metric at the further network node.

According to various, but not necessarily all, example embodiments there is provided: a computer program product operable, when executed on a computer, to perform the method of: receiving, from a user equipment, an indication that a plurality of timing advance loops are supported by the user equipment; transmitting, to the user equipment, a configuration for measuring downlink reference signals; receiving, from the user equipment, an evaluated indication of a predicted uplink signal quality metric at a further network node.

A non-transitory computer-readable medium storing computer program code including instructions that, when executed by a processor, cause apparatus to perform the steps of: transmitting, to a network node, an indication that a plurality of timing advance loops are supported; receiving, from the network node, a configuration for measuring downlink reference signals; performing measurements on the downlink reference signals according to the configuration; evaluating, based on the measurements, an indication of a predicted uplink signal quality metric at a further network node based upon use of a common timing advance loop; and transmitting, to the network node, an indication of the evaluated indication of a predicted uplink signal quality metric at the further network node.

A non-transitory computer-readable medium storing computer program code including instructions that, when executed by a processor, cause apparatus to perform the steps of: receiving, from a user equipment, an indication that a plurality of timing advance loops are supported by the user equipment; transmitting, to the user equipment, a configuration for measuring downlink reference signals; receiving, from the user equipment, an evaluated indication of a predicted uplink signal quality metric at a further network node.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

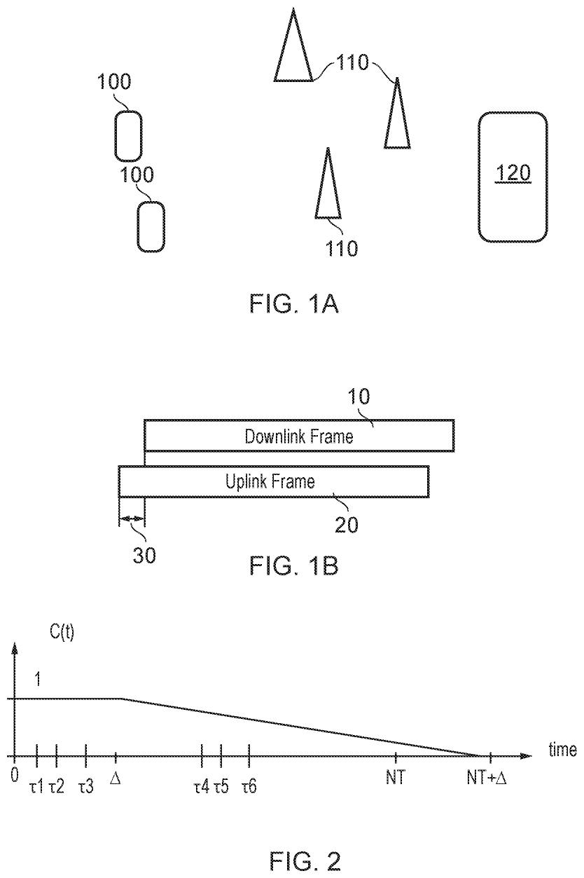

FIG. 1A illustrates schematically a general wireless communication system network architecture;

FIG. 1B illustrates schematically a relationship between downlink frame and uplink frame timing;

FIG. 2 illustrates graphically the contribution of a UE transmitted signal to signal power in dependence upon arrival time at a receiving node;

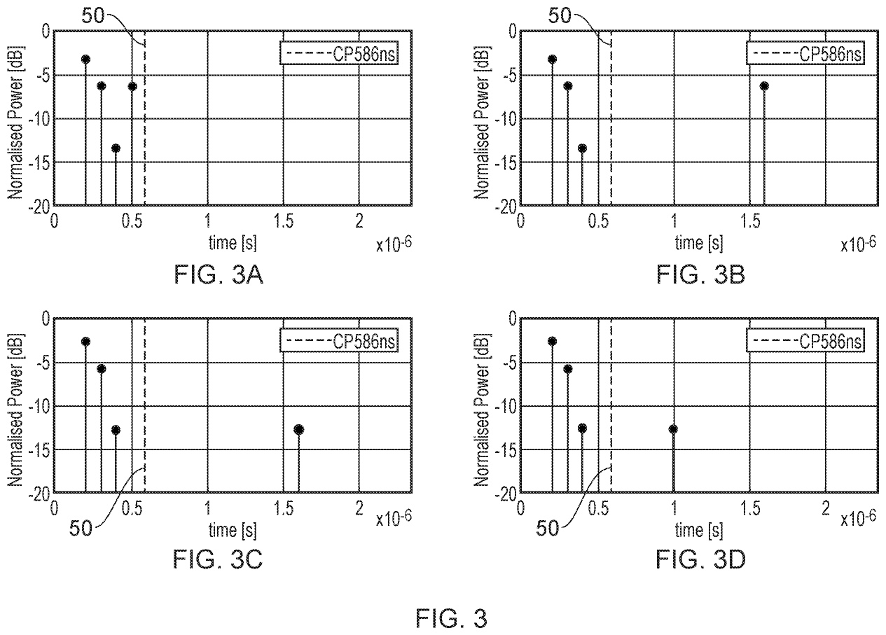

FIGS. 3A to 3D illustrate graphically four examples of different estimated Power Delay Profiles

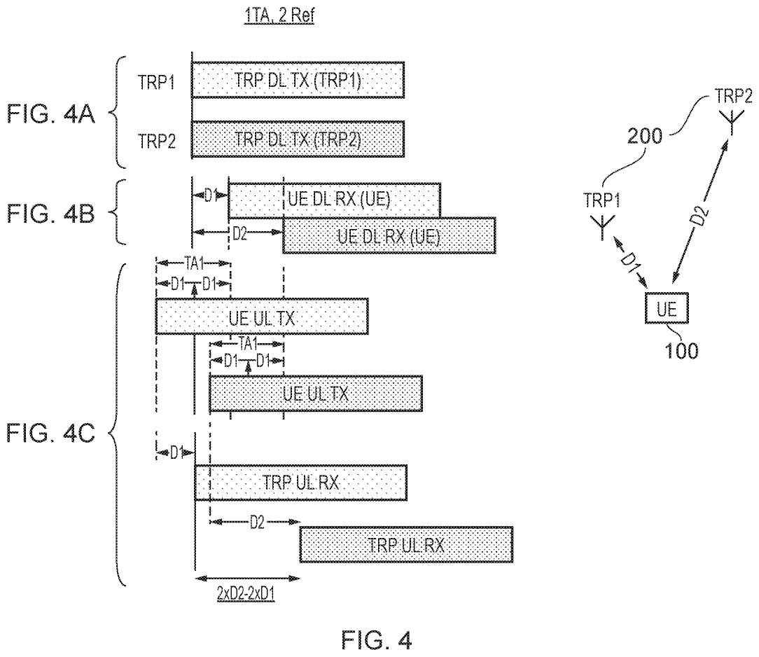

FIG. 4A to 4C illustrate schematically timing of uplink and downlink signals at both a UE and two TRPs in the case that the UE implements a single Timing Advance (TA) value;

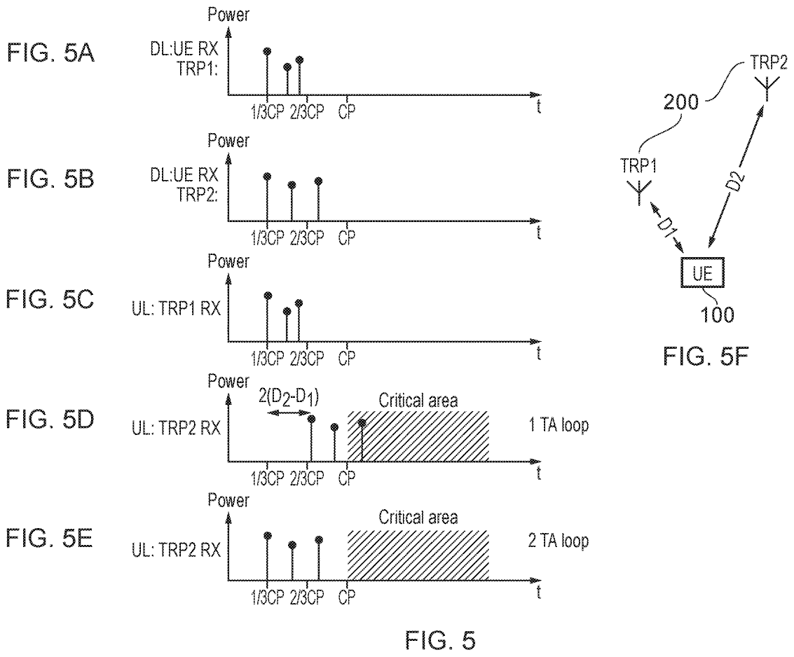

FIGS. 5A to 5E illustrate example Power Delay Profiles (PDPs) from and to different TRPs depending on whether 1 or 2 Timing Advance Loops are implemented by a UE;

FIG. 5F illustrates schematically a UE which is configured to receive from two TRPs in a mTRP network;

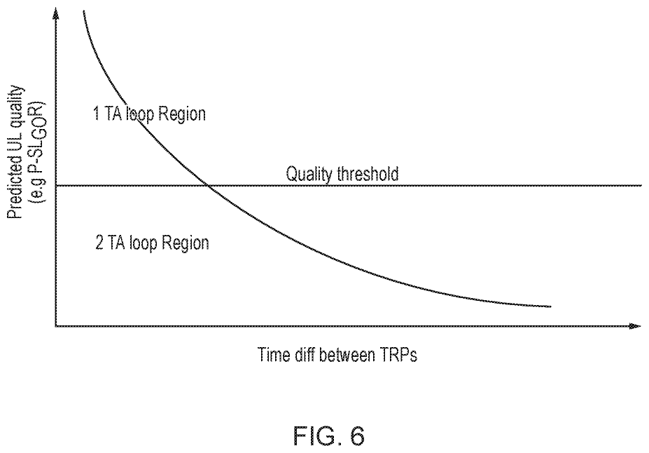

FIG. 6 illustrates graphically an example of how a predicted UL quality metric (for example, P-SI_{ISCI}R) for a UE operating using a single TA loop decreases as time difference of arrival of a UE UL signal increases between 2 TRPs;

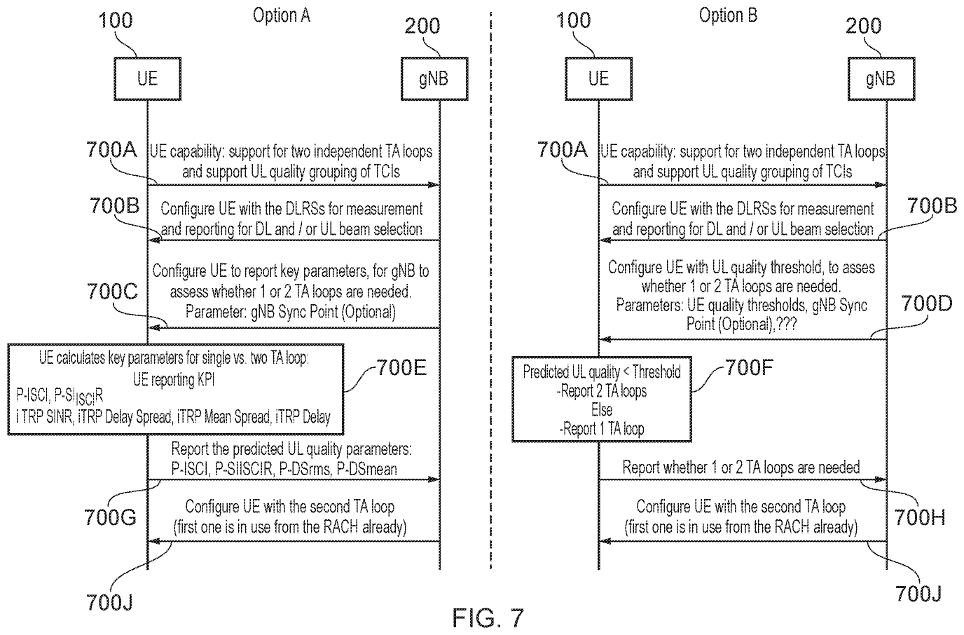

FIG. 7 is a signalling diagram indicating signalling between a network and user equipment in accordance with two possible arrangements;

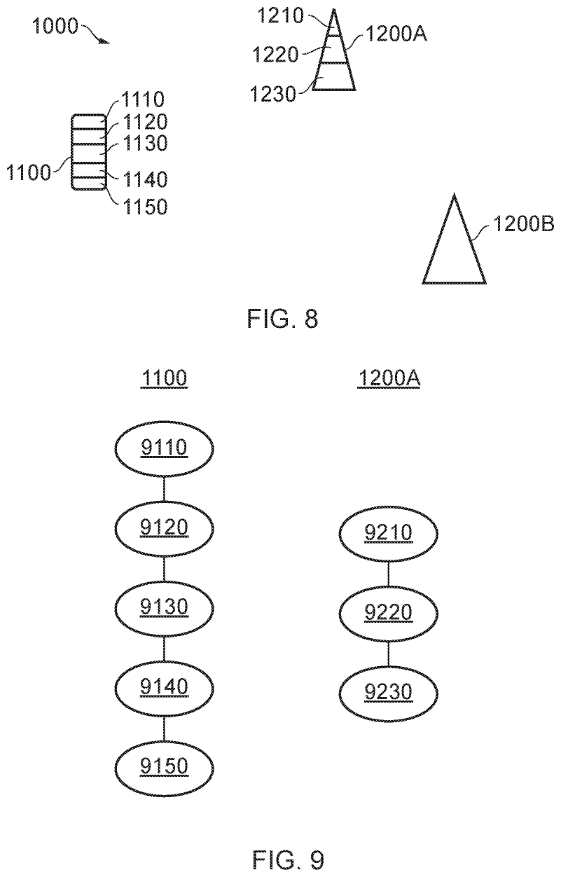

FIG. 8 illustrates schematically some components of a network including nodes according to some arrangements; and

FIG. 9 illustrates schematically steps of methods performed in accordance with some arrangements.

### DETAILED DESCRIPTION

Before discussing aspects in any more detail, first an overview of the context in which aspects are to be understood will be provided.

FIG. 1A illustrates schematically a general wireless communication system network architecture. Whilst arrangements are described in relation to one possible network architecture, it will be appreciated that the principles of operation in accordance with arrangements may be applied across a range of network architectures without undue burden. In particular, arrangements are described in relation to an access architecture based on long term evolution advanced (LTE Advanced, LTE-A) or new radio (NR), also known as fifth generation (5G), network architectures, but arrangements are not envisaged to be restricted to such an architecture.

Examples of other architectures and systems include, for example, universal mobile telecommunications system (UMTS) radio access networks (UTRAN or E-UTRAN); long term evolution networks (LTE); architectures including Non-terrestrial Networks (NTN); wireless local area network (WLAN or WiFi) networks and similar.

FIG. 1A illustrates schematically some main components of an example radio access network. Typically a network will comprise a plurality of User Equipment (UE) devices 100.

A UE 100 typically comprises a portable computing device that includes wireless mobile communication functionality. UE devices include, but are not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. A UE device may include machine type communication devices (MTC devices) and various devices which have capability to operate in an Internet of Things (IoT) network.

The UEs are configured to be in wireless communication with one or more network access node 110. The network access node, for example, gNB, provides a radio frequency region of coverage called a cell. UE communicate with the network access nodes using one or more communication channels in a cell. The radio communication link from UE towards a network node is called uplink (UL) and the radio communication link from a network node towards a UE is called downlink (DL).

A communication system typically comprises more than one network access node. Those network access nodes may also be configured to communicate with one another over links, wired or wireless and form the “network side” of the architecture. The network side nodes may include a computing device configured to control the radio resources of the communication system. The network access node may also be referred to as a base station (BS), an access point or similar.

A network access node 110 typically comprises, or is coupled to, a transceiver. From a transceiver of a network access node, a connection is provided to an antenna unit that establishes bi-directional (or duplex) radio links to UE 100. The antenna unit may comprise a plurality of antennas or antenna elements. The network access nodes are typically also connected to core network 120.

Different duplexing schemes result in different interference situations and also to different way of predicting channel of interference. For example, in time-division duplexing (TDD) schemes, the bi-directional channels, say uplink and downlink, are highly correlated within a channel coherence time. In frequency-division duplexing (FDD) schemes, the bi-direction channel are typically separated, so that only long-term information is similar in uplink and downlink, for example. Examples of such long-term information include: dominant signal arrival or signal transmit directions. In TDD and in similar duplexing schemes, the instantaneous channels are reciprocal, whereas in FDD systems, only long-term or statistical reciprocity typically holds.

It will therefore be appreciated that assumed reciprocity features of operation within a network can be used in support of estimation techniques. For example, it may be possible to hypothesize something at UE based on measurements made at the UE. Arrangements described in more detail below may, for example, utilise UE based measurement-derived information, in conjunction with assumed operation of a timing advance loop to “guess” likely signal-interference information at a node receiving transmissions from the UE.

Some networks allow UEs to establish concurrent connection to more than one network access node, or “Transmission and Reception Point” (TRP). In a multi-TRP scenario, UE are able to connect to multiple transmission reception points (TRPs).

Beam management techniques are used when UE form an initial connection with a network, and ongoing management occurs while the UE is in connected state. In connected state, operation of transmitting beams and receiving beams may be refined. Beam management defines a set of functionalities to assist UE when setting parameters of reception (Rx) and transmission (Tx) beams for downlink reception and uplink transmission, respectively.

### Timing Advance Background

When a UE is communicating with a TRP the propagation delay for a radio frequency (RF) signal to travel the distance between the TRP and the UE and vice versa will delay the signal in both Downlink (DL) and Uplink (UL) directions. In order for a TRP to decode a signal from multiple UE, each having different distances to the TRP and hence different propagation delays, a timing advance (TA) procedure is provided.

According to the TA procedure, each UE is requested to advance its UL signal transmission in order for it to be received at a defined time at the TRP. That is to say, transmission times of each UE are selected such that substantially simultaneous arrival at a TRP is achieved. All UEs of a TRP are then synchronized such that each gNB has a single Fast Fourier Transform (FFT) timing for all the incoming signals from different UEs. In other words, different UEs have a shared target synchronization point. Inter symbol interference occurs if the UEs do not have a shared synchronisation point. Multiple UL symbols overlap if signals from multiple UEs are not received aligned. That is to say, without alignment, cross-user interference may occur.

Furthermore, the TA loop mechanism operates to try to ensure that an UL signal received at the TRP will have no overlap with a subsequent DL transmission.

Interference may also occur within a network as intra-user or cross-user interference.

The different UEs connected to the same TRP apply a dedicated TA value per UE, hence all signals will arrive at the TRP in sync, and with minimum inter-symbol overlap.

The DL signals from the TRP arrive at the different UEs at different time instances depending on the different propagation delays.

FIG. 1B illustrates schematically a relationship between downlink frame and uplink frame timings as well as the an indication of how a timing advance offset operates. As shown in FIG. 1B an offset 30 is applied to uplink frames 20, but not downlink frames 10. Timing advance is a negative offset 30, typically applied at the UE, between the start of a received downlink subframe 10 and a transmitted uplink subframe 20. This offset at the UE is necessary to ensure that the downlink and uplink subframes are synchronised at the network side. Typically the Timing Advance (TA) offset 30 is equal to 2× propagation delay determined to apply between the network side and a UE and assumes that the same propagation delay value which is determined in relation to the downlink also applies to the uplink direction.

Implementing a Timing Advance enables an alignment, up to some desired resolution, in time of UL signals from different UEs to the same TRP. In FR2 New Radio (NR) having a Sub-Carrier Spacing (SCS) of 120 kHz, the Cyclic Prefix (CP) is 590 ns. The TA step size is 65.1 ns, hence there are approximately 9 steps within the CP length. In the Timing Advance Command, which is sent in a Medium Access Control (MAC) Control Element (CE), the UE can be requested to change the UL timing by up to +/−31 times the step size mentioned above. The length of the step size is the limit of the accuracy that the gNB can time align an UL signal from one UE, inside the gNB CP receive window. In RAN4, 3GPP has defined a minimum synchronization for the case of Carrier Aggregation (CA) in intra-band Contiguous, that minimum synchronisation being 260 ns.

UL Quality Evaluation in mTRP Scenarios when Channel Delays are Outside CP

The are many different block transmission methods, such as OFDM, OFDMA, Multi-carrier CDMA, precoded-OFDM and each can include transmission methods that decouple subsequently transmitted blocks from each other. The decoupling is done using a cyclic prefix or zero-padding. For example, in OFDM modulated signals each OFDM symbol, in time, consists of a data sequence preceded by a cyclic prefix (CP). The cyclic prefix is a copy of the last part of the FFT-modulated data sequence, and it is designed to extend the range of multipath delays within which the subcarriers of the OFDM symbol can remain orthogonal. In other words, if all the multipath delays of the channel are within the CP then the receiver can maintain orthogonality between subcarriers as long as adequate synchronization has been performed.

In general, if the delays are all captured within the CP length, the receiver will see full orthogonality between consecutive OFDM symbols as well as between subcarriers of same OFDM symbol leading to no signal degradation. However, if any multipath delays are larger than the CP length the received signal performance will suffer from both inter-symbol and inter-subcarrier interference.

Examples of theoretical background to properly describe analytically the amount of interference relative to the signal power in a CP-OFDM system include:
[1] H. Steendam, M. Moenclaey, “Analysis and Optimization of the Performance of OFDM on Frequency-Selective Time-Selective Fading Channels,” IEEE Trans. Commun. vol. 47, pp. 1811-1819, dec. 1999 and
[2] M. Batariere, K. Braum, T. P. Krauss “Cyclic Prefix Length Analysis for 4G OFDM Systems,” VTC '04, Los Angeles, USA, sept. 2004 and can be expressed as a Signal to Interference and Noise Ratio (SINR).

From [1] the following expression of SINR can be found:

$$SINR = \frac{{P}_{s}}{{P}_{i} + {σ}_{w}^{2}}$$

In this document SI_{ISCI}R is defined such that:

$${SI}_{ISCI} R = SINR$$

Where the desired signal power (Pₛ) is given by:

$${P}_{s} = {\sum }_{i = 0}^{{N}_{t} - 1} {C ( {τ}_{i} )}^{2} E \{ {\vert a [ i ] \vert}^{2} \}$$

And the interference power (Pᵢ) is given by:

$${P}_{i} = {\sum }_{i = 0}^{{N}_{t} - 1} {( 1 - C ( {τ}_{i} ) )}^{2} E {\vert a [ i ] \vert}^{2}$$

$$ISCI = {P}_{i}$$

FIG. 2 illustrates graphically the contribution of a UE transmitted signal to signal power in dependence upon arrival time at a receiving node. It can be seen that whether a signal contributes to the received signal, or whether it is seen as interference depends upon whether it is received at a receiving node before or after expiry of one CP period.

The weight function C(τ) is used to weigh the individual delay taps according to their position in the OFDM symbol.

When all the delay taps (τ1, τ2, τ3) are within a CP at a receiving node (between 0 and Δ in FIG. 2) and have a weight of 1, they contribute only to the signal power (Pₛ), and not to the interference power (Pᵢ).

When delays are between the CP (i.e. >4) and the full OFDM symbol length (NT) (e.g. τ4, τ5, τ6), the weighting gradually changes from signal power to interference power.

The above equation for Pᵢ is referred to herein as ISCI (Inter Symbol and Carrier Interference), and P-ISCI is the Predicted Inter Symbol and Carrier Interference. It is a calculation of the inter symbol and inter carrier interference power caused by having delay taps outside the CP length.

Another measure used herein is: Average Delay Spread (DSₘₑₐₙ), defined as:

$${DS}_{mean} = \overline{τ} = \frac{{\sum }_{i = 0}^{L - 1} {g}_{i} {τ}_{i}}{{\sum }_{i = 0}^{L - 1} {g}_{i}}$$

### And the Root Mean Square Delay Spread (DSᵣₘₛ)

$${DS}_{rms} = \sqrt{\frac{{\sum }_{i = 0}^{L - 1} {\vert {a}_{i} \vert}^{2} {( {τ}_{i} - \overline{τ} )}^{2}}{{\sum }_{i = 0}^{L - 1} {\vert {a}_{i} \vert}^{2}}}$$

Where gᵢ=|αᵢ|², and τᵢ is the delay of each delay tap in the PDP (Power Delay Profile).

$$( {σ}_{w}^{2} )$$

is the variance of the white gaussian noise, assumed to be zero herein.

FIGS. 3A to 3D illustrate graphically four examples of different estimated Power Delay Profiles and the consequence of their arrival time inside, or outside a cyclic prefix (CP) length 50. The table below sets out an associated calculated predicted quality for each example.

| | | | |
|---|---|---|---|
| a) | b) | c) | d) |

| | | | | | | | | |
|---|---|---|---|---|---|---|---|---|
| P-SI_{ISCI}R | 40 | dB | 12.4 | dB | 18.6 | dB | 22.4 | dB |
| P-ISCI | −40 | dB | −12.6 | dB | −18.7 | dB | −22.4 | dB |
| P-DSₘₑₐₙ | 302 | ns | 565 | ns | 321 | ns | 286 | ns |
| P-DSᵣₘₛ | 123 | ns | 582 | ns | 326 | ns | 189 | ns |

Each PDP of FIG. 3 comprises 4 delay taps having the following features:
FIG. 3A: all delay taps are within the CP length, no interference and P-SI_{ISCI}R=40 dB (maximum of hardware capability)
FIG. 3B: one delay tap at −6 dB is outside CP at 1.6 us; P-SI_{ISCI}R=12.4 dB
FIG. 3C: one delay tap outside CP is lowered to −12 dB; P-SI_{ISCI}R=18.6 dB
FIG. 3D: the single delay tap outside CP has lower delay 1 us, hence lower P-SI_{ISCI}R=22.4 dB

In all examples of FIG. 3A to 3D it is assumed that the first delay is positioned at ⅓ CP. That means assuming that the gNB will align the timing of the UL signal (for example, by using the Timing Advance procedure) from the UE, so that the first reflection is positioned ⅓ within the CP at the gNB receiver. The UL timing alignment is controlled by the gNB using the timing advance command (TAC). The ⅓ is introduced to allow for some robustness at the receiver to timing errors related to synchronisation, and it is a common value used in 3GPP. However, the actual synchronization point in the gNB hardware is gNB implementation specific.

The interference considered here is the inter-symbol and inter subcarrier interference caused by the signal taps received outside of the CP.

The significance of appropriate application of a Timing Advance by UE within a network can therefore be appreciated.

Aspects described in more detail below seek to address consequences of multi Timing Advance (multi-TA) functionality that is to be provided in wireless communication networks. It may be desirable to enhance multi-TRP operation especially in FR2 frequency range in cases where a UE has capability to use two uplink (UL) streams from two panels for simultaneous transmission either to one or two receiving TRPs.

Multi-TRP (mTRP) is a significant feature for beam management. 3GPP Rel-16 deals with mTRP for simultaneous Physical Downlink Shared Channels (PDSCH) with single Downlink Control Information (DCI) (for both Frequency Division Multiplexing (FDM) & Space Division Multiplexing (SDM)); Rel-17 supports mTRP for Physical Uplink Control Channels (PUCCH) and & Physical Uplink Shared Channels (PUSCH) with Time Division Multiplexing (TDM). Rel-18 will address simultaneous PUCCH & PUSCH and UE multi-panel transmissions. In this context Timing Advance (TA) is an issue to be addressed.

It is possible to allow 2 parallel Timing Advance values for mTRP multi-DCI configured UE.

UL Timing in mTRP Scenarios

It is possible for a UE to have a capability to use either single or multiple TA loops

FIG. 4 illustrates a UE 100 in communication with two TRPs 200. The TRPs are each a different radio propagation delay from the UE 100. TRP1 is a propagation delay of D1 away from UE 100 and TRP2 is a propagation delay of D2 away from UE 100.

FIG. 4A to 4C illustrate schematically timing of uplink and downlink signals at both a UE and two TRPs in the case that the UE 100 implements a single TA value (i.e. 1 TA) for the two TRPs TRP1, TRP2, each TRP 200 having its own reference time.

FIG. 4A shows the timing of two DL signals from two TRP as they are transmitted simultaneously from the two TRPs. The implementation shown in FIG. 4A relates to a network using FR2, operating in Time Division Duplexing (TDD) bands and therefore it is assumed that all TRPs are synchronized in time.

FIG. 4B shows the timing at a UE, and the two DL signals from the two separate TRPs are likely be received at different times due to the different distances and radio propagation characteristics between the UE and each of the two TRPs. D1 is the (one way) propagation delay between TRP1 and the UE, and D2 is the (one way) propagation delay between TRP2 and the UE.

FIG. 4C illustrates that a UE 100 is configured such that the UL transmission time will be advanced, relative to the received time, by a single timing advance TA1. The UE UL signal for TRP1 is transmitted at 2×D1=TA1 time before the reception of the signal from TRP1, hence at TRP1 the UE UL signal is received in substantial alignment with the DL signal.

If the UE is configured to operate using a single TA loop, the UE UL signal for TRP2 is also transmitted 2×D1 (TA1) time before the reception of the signal from TRP2, hence as illustrated in the figure the UL signal to TRP2 is received at TRP2 with a time difference of (2×D2−2×D1) thus introducing a lack of synchronization at TRP2 relative to TRP1.

In the example shown in FIG. 4, the timing of the transmitted signal from the 2 TRPs is synchronous. The timing of reception of the DL signal at the UE depends on propagation delay. Relative to the UE DL receive time, the UL signal is transmitted by the UE using a single TA loop i.e. a timing advance that is time shifted by the TA value relative to one TRP-specific DL UE reception, e.g. corresponding to D1 in the case of single TA aligned with TRP1.

### Numerical Example

Assuming a distance between UE and TRP1 of 30 m, and a distance between UE and TRP2 of 80 m.

The delay values D1 and D2 are: D1=100 ns and D2=267 ns. With this example, the UL signal for TRP2 will be received at the TRP2 with a delay given by

$$2 \times D 2 - 2 \times D 1 = 2 \times 267 ns - 2 \times 100 ns = 334 ns$$

It can be understood from FIG. 4 that a single TA loop in a mTRP network may not be suited to efficient UE operation. To improve overall operation of a mTRP network, a UE may be provided with a multi-TA loop capability. That multi-TA loop capability may be used, for example, in relation to FR2.

As set out below, it is possible to make an estimation or calculation of a contribution of one or more signals, whether received inside or outside CP, as well as a level of inter-symbol and inter subcarrier interference from signals received outside the CP length, for a given channel PDP. This signal quality is expressed in SINR for each channel instance. In general, the more of the channel delay power that is located outside the CP length, the lower SINR the receiver will get. Nonetheless, a simple calculation based only on CP length may not be representative of whether it would be advantageous for a UE or network to implement multi-TA capability.

### Summary of Context

The following different metrics, all describing a Power Delay Profile (PDP), have been introduced:
SI_{ISCI}R: Signal to Interference Ratio, where interference is the interference caused by the Inter Symbol and Inter Carrier (ISCI), due to PDP taps outside CP length.
ISCI: Inter Symbol and Inter Carrier Interference. A measure of the power of the Inter symbol and Inter Carrier interference due to PDP taps outside CP length.
DSₘₑₐₙ: Defines the average delay of the different taps in a Power Delay Profile (PDP).
DSᵣₘₛ: Defines the spread of the different taps in a Power Delay Profile (PDP).

Herein P-SI_{ISCI}R, P-ISCI, P-DSₘₑₐₙ and P-DSᵣₘₛ are used to refer to the UE predicted version of the different metrics referred to above.

FIGS. 5A to 5E illustrate example Power Delay Profiles (PDPs) from and to different TRPs depending on whether 1 or 2 Timing Advance Loops are implemented in the scenario illustrated schematically in FIG. 5F.

FIG. 5F illustrates a UE 100 in communication with two TRPs 200. The TRPs are each a different radio propagation delay from the UE 100. TRP1 is a propagation delay of D1 away from UE 100 and TRP2 is a propagation delay of D2 away from UE 100

FIG. 5A illustrates schematically an example of the UE estimated Power Delay Profile (PDP) for downlink (DL) signals coming from TRP1. The first reflection is aligned with ⅓ CP.

FIG. 5B illustrates schematically an example of the UE estimated PDP for downlink signals coming from TRP2. The first reflection is again aligned with ⅓ CP.

FIG. 5C illustrates schematically an example of a TRP1 estimated PDP based upon an uplink signal transmitted by the UE. The Timing Advance TA of UE 100 is “set” by the closest TRP, namely TRP1, and the UE is configured to make uplink transmissions with a Timing Advance (TA) of 2×D1, such that the first reflection received at TRP1 from the UE 100 is approximately aligned with ⅓ CP.

FIG. 5D illustrates schematically an example of the TRP2 estimated PDP for the UL signal from the UE 100 in the case that the UE is configured to apply one TA loop. Since the single TA loop is aligned to TRP1, and because TRP1 and TRP2 are different distances from the UE and therefore have different radio propagation delays, the first reflection at TRP2 is delayed by that different distance from UE to the two TRPs 2 (D2−D1). The result is that part of the PDP may be subject to a delay which is greater than the CP length and hence can potentially interfere/corrupt the data symbols. In the example shown in FIG. 5D one delay tap is likely received at TRP2 from the UE 100 in the critical area where inter symbol and inter carrier interference will be generated.

FIG. 5E illustrates schematically an example of the TRP2 estimated PDP for the UL signal from the UE in a case where the UE is configured to apply two TA loops. Accordingly, the UE 100 may be configured to use a TA of 2×D2 in communication with TRP2. Because 2 TA loops are enabled, implementation by the UE of the second TA loop for TRP2 can help to ensure that the first delay tap in the PDP at TRP2 is kept at around ⅓ CP.

Arrangements recognise that whilst being outside the CP length, as shown in FIG. 5D, is an indicator of whether any inter symbol and inter carrier interference may be generated, the functional significance of that interference may differ. In particular, being outside the CP may cause minimal interference, depending upon how far outside the CP the UE uplink signal falls. Similarly, depending upon hardware capability, a TRP may be able to tolerate a degree of interference, even if the UE uplink signal falls outside the CP. In such a scenario, it may not be advantageous to overall network efficiency for the UE and network to implement a multiple TA configuration.

In other words, the simple metric of being received inside or outside CP is not an accurate enough metric to decide on whether a UE should be a user of a 1 or 2 TA loop configuration. Indeed, even when the signal is received outside of CP, it may still be decoded by gNB though SINR is degraded. Arrangements described herein recognise that it may be useful to implement a different metric to facilitate an assessment of whether it may be advantageous to overall network operation to implement a single or multiple loop TA loop configuration.

Before discussing the example embodiments in any more detail, first an overview of arrangements will be provided.

Arrangements may provide an apparatus, for example, user equipment, comprising: means for indicating to another node, that a plurality of timing advance loops are supported; means for receiving, from the another node, a configuration for measuring received reference signals from the another node; means for performing measurements on the received reference signals according to the configuration; means for evaluating, based on the measurements, an indication of a predicted signal quality metric in relation to at least one of: the another node or a further network node based upon conditional use of at least one timing advance loop; and means for transmitting information relating to the evaluated indication of a predicted signal quality metric at the at least one of the another node and further network node.

The another node may comprise a network node, that network node may be the primary or serving network node with which the user equipment is communicating. The further node may also comprise a network node, it may be a different network node with which the user equipment is communicating. The received reference signals may comprise downlink signals. The received reference signals may comprise signals received from the another node and/or from the further node. The evaluated indication of a predicted signal quality metric may comprise an evaluated indication of a predicted uplink signal quality metric.

On the network side, arrangements may provide: an apparatus, for example, network node, comprising: means for determining that a plurality of timing advance loops are supported by a node; means for transmitting, to the node, a configuration for measuring received reference signals; means for receiving, from the node, information relating to an evaluated indication of a predicted signal quality metric at the least one of another node or a further network node.

The node may comprise user equipment. The further network node may comprise a network node. The received reference signals may comprise downlink signals. The received reference signals may comprise downlink signals received at the user equipment from the another node and/or from the further node. The evaluated indication of a predicted signal quality metric may comprise an evaluated indication of a predicted uplink signal quality metric.

Arrangements described relate to enhancements to the decision mechanism in support of whether to configure a single or more TA loop in support of m-TRP operation.

Arrangements recognise that a UE may be configurable to support calculation of an estimate of a predicted UL quality metric for simultaneous UL transmission, for example, on groups of Transmission Configuration (TCI) states. According to one example, the TCI states may be identified by their corresponding Downlink Reference Signal (DL RS) and the predicted UL quality may be based on calculations based upon factors including, for example, UL time alignment versus CP length for a single TA loop. The output of such calculation(s) may be compared, for example by a UE, or by the network, against a threshold UL quality metric. That comparison against a threshold may be used as a criteria against which a network or UE can assess whether one or more TA loops are most appropriate for implementation by the UE within the network. For example, arrangements may provide a threshold of predicted UL quality against which the UE or network can assess whether implementation of a single or multiple TA loops would provide efficient operation.

According to arrangements described, a UE may be configured to evaluate, measure or report one of more parameter which allow for calculation of a predicted UL quality at a TRP. The calculation of predicted UL quality can comprise a calculation of one or more quality metric. The calculated quality metric may comprise, for example: a predicted Inter-Symbol-and-Carrier-Interference (P-ISCI) where the ISCI is the inter-Symbol plus inter-Carrier Interference power caused by UL timing misalignment at a TRP when using 1 TA loop. Alternatively, the calculated quality metric may comprise a predicted SI_{ISCI}R, where the interference power I_{ISCI} is that which is solely attributable to the ISCI. SI_{ISCI}R is defined as a Signal to Interference Ratio, when taking into account an UL signal misalignment at a TRP caused by using 1 TA loop.

Arrangements described may utilise one or a combination of the following metrics and definitions in support of calculation of one or more predicted UL quality metric:
P-ISCI (Predicted Inter Symbol sub-Carrier Interference)
P-SI_{ISCI}R (Predicted Signal to Interference (Inter Symbol and -Carrier) Ratio)
P-DSrms (Predicted Delay Spread RMS)
P-DSmean (Predicted Delay Spread mean)

Arrangements recognise that a UE can be configured to measure, report or assess one or more operational characteristic of the network. Those operational characteristics may be used to calculate, estimate or predict the one or more UL quality metric. The UL quality metric may be assessed, calculated or estimated for groups of TCI states.

According to arrangements, UE may be configured to perform the assessment or calculation of an UL quality metric explicitly and then reporting it to the network or may implicitly report it to the network by indicating a preference for a single or multiple TA loop, or the UE may report the measured, reported or assessed one or more operational characteristic of the network relating to downlink reception, such that the network may itself be configured to make an assessment or calculation of a predicted UL quality metric associated with the UE which can then be used to determine whether or not a UE is a candidate for implementation of a single or multiple TA loop.

Arrangements recognise that assessment of a predicted UL quality at a TRP can be used to assist a gNB when making a choice between, for example, 1 or 2 TA loops in relation to a UE. The calculated UL quality metric may represent a cost in SINR of decoding signal tap(s) which arrive at a TRP from a UE outside of CP length due to implementation at the UE of a single TA loop.

By way of example, if a predicted UL quality (e.g. P-SI_{ISCI}R) for 1 TA loop is calculated and determined to be sufficient to allow for successful decoding of the signal by the gNB, then use of a single TA loop may be selected or maintained. Alternatively, if the estimated UL Quality is calculated to not meet a sufficient threshold, a gNB may be operable to decide to use, for example, 2 TA loops. In some arrangements, if the estimated UL signal quality at a TRP is calculated to be insufficient and does not meet a predetermined threshold, a UE may be configured to indicate a preference for implementation of operation using 2 TA loops.

According to arrangements, the estimated UL signal quality at a TRP is based upon measurements and parameters determinable at the UE. For example, a UE may be configured to calculate an estimate of UL quality at a TRP from measured DL RS. In an estimated UL SINR, signal estimation may be based on reciprocity and the interference estimation may only consider inter-symbol interference from tap(s) detected after the end of CP length at the TRP of interest. Neighbour cell interference experienced at a gNB can be handled directly by gNB and is, according to arrangements, largely irrelevant and independent of a 1 vs 2 TA loop decision.

Arrangements recognise that measurements made at the UE can be utilised to make an estimate of a predicted UL signal quality metric at a TRP. That estimation or prediction of UL signal quality may allow, in some implementations, a UE to assess and directly indicate to network whether the amount of signal power received outside the CP length for given propagation delays is critical to UL mTRP transmission or not and therefore support a decision making process of whether a capable UE could benefit from implementation of, for example, a second TA loop.

FIG. 6 illustrates graphically an example of how a predicted UL quality metric (for example, P-SI_{ISCI}R) for a UE operating using a single TA loop decreases as time difference of arrival of a UE UL signal increases between 2 TRPs.

According to arrangements described, a predicted UL quality metric value is calculated. FIG. 6 illustrates generally the degradation of predicted UL quality metric as propagation delay difference between a UE and TRPs increases. The prediction may be directly calculated by the UE and reported to network explicitly or implicitly.

According to arrangements described, the time difference of arrival can be calculated by a UE using, for example, the DL RS of each TCI state. Reciprocity in the downlink/uplink arrangement and beam correspondence is assumed, for example in a TDD FR2 system. By way of example, a time difference between signals received from different TRPs may be calculated by a UE based on a measurement from first tap to first tap of each received DL RS for each TCI state.

FIG. 6 shows a horizontal “threshold”. That line is representative of a predicted UL quality metric representative of when a transition between single or multiple loop TA may be beneficial to operation of the UE within the network. When the predicted UL quality metric is above the threshold, a single TA loop implemented by the UE is likely to be sufficient to ensure the UE can transmit successfully with insignificant ISCI to, for example, 2 TRPs. Conversely, when the predicted UL quality metric is below the threshold, it may be beneficial for the UE needs to be configured with 2 TA loops so that the 2 TRPs can successfully receive transmissions made by the UE.

Whilst assessing whether a radio propagation delay between a UE and a TRP, together with a value of a single TA implemented by a UE against CP length offers one measure against which it is possible to decide whether there is a requirement to implement a further TA loop, arrangements described herein recognise that the transition point may be more accurately assessed if the impact of falling outside the CP length, and capabilities of network nodes involves in the communication can be taken into account.

Accordingly, arrangements described introduce implementation of a predicted uplink quality metric threshold and associated signalling. According to arrangements, an acceptable level (threshold) relating to a predicted UL quality metric for implementation of a single TA loop at a UE may be decided by, for example, the gNB. That threshold may be signalled to the UE. Alternatively, the threshold may be selected as a UE requirement and specified.

In summary, arrangements provide that, according to some implementations, a UE is configured to support introduction of a predicted uplink signal quality threshold against which a decision regarding whether or not it could be advantageous to implement more than a single TA loop can be assessed. The threshold may be introduced to network operation in various ways, including, for example, by means of: RRC configuration from network; dynamic indication from network e.g. MAC or DCI; pre-determined value in specification text; or a UE chosen value which is reported to the network.

Arrangements may provide implementations according to which a UE may be configured to calculate a predicted UL quality metric for m-TRP operation if the UE operates with a single TA loop. The UE may be configured to make such a calculation for example, for groups of TRPs for simultaneous UL transmissions. The calculation of predicted UL signal quality metric may be, for example, based upon one or more characteristic of operation measurable at the UE. Such a characteristic may, for example, include measurement from a Transmission Configuration Indicator (TCI) Downlink Reference Signal (DL RS), for example, Synchronization Signal Block (SSB) or Channel Status Information Reference Signal (CSI-RS).

Arrangements may provide implementations according to which a UE may be configured to report a calculated predicted UL quality metric to a network. The report may be an explicit report of a calculated value, for example, the UE may be configured to report a predicted UL quality metric. Alternatively, the UE may be configured to report a predicted UL quality metric implicitly, for example, by indicating whether the calculated value has passed a threshold or not, or in the form of part of a TA loop indication (single loop or more than one loop) for groups of TCI states.

In other words, arrangements may provide for implementations according to which a UE may be configured to directly indicate a calculated predicted UL quality metric to a gNB. Alternatively, a UE may be configured to compare the calculated predicted UL quality metric against a threshold. Based upon that comparison, the UE may be configured to indicate a preference for operation using, for example, 1 or 2 TA loops from the gNB accordingly. The calculated predicted UL quality metric is used to provide information regarding, for example, each TCI combination, allowing an assessment to be made as to whether it is more appropriate for the UE to use a single or more than one TA loop.

Functionally, the predicted UL quality metric represents an indication of UL quality a gNB can expect if the UE uses a single TA loop, when taking into account likely interference, for example, inter-symbol and/or inter-subcarrier interference (i.e. ISCI) caused by UL time misalignment.

In implementations of arrangements in which an acceptable (threshold) level of a predicted UL quality metric is determined or selected by a gNB, the gNB may be configured to make such a determination or selection based on a range of factors. Such factors may, for example, include: use case; type of data; QoS; hardware capability or similar. According to implementations of arrangements, and as described in more detail below, a network may be operation either to compare a UE reported predicted UL quality metric against a determined or selected threshold or to configure the UE to compare the calculated UL quality metric with a selected or determined UL quality threshold and report the result of such a comparison.

FIG. 7 is a signalling diagram indicating signalling between a network 200 and user equipment 100 in accordance with two possible arrangements. As shown in FIG. 7, information may be provided such that an assessment of whether the user equipment may operate more efficiently within the network under a single or multiple TA loop implementation. Such information may be provided to support a decision as shown in, for example, the two implementations represented schematically in FIG. 7.

### Option A

According to the first implementation shown in FIG. 7, a network node 200, for example, gNB, is configured to use a reported predicted UL quality metric (for example, P-SI_{ISCI}R) from the UE. The network node 200 is configured to use the reported predicted UL quality metric from the UE 100 to assess whether a UE should operate using 1 or 2 TA loops.

### Option B

According to the second implementation shown schematically in FIG. 7, a UE 100 operating within a network is configured to determine a UL quality metric threshold. Accordingly, the UE 100 operating in accordance with such an implementation may be configured to compare the determined UL quality metric threshold with a calculated UE predicted UL quality metric. If the calculated predicted UL quality metric is within the determined UL quality threshold, the UE may be configured to report that operating using a single TA loop is sufficient. If the calculated predicted UL quality metric is not within the determined UL quality threshold, the UE may be configured to report that a single TA loop is not sufficient and that operation using, for example, two TA loops could improve the likelihood of uplink transmissions made by the UE being received successfully at a receiving mTRP node.

FIG. 7 shows, in the form of a signalling flow diagram, implementation options A and B described generally above. FIG. 7 shows signalling between UE 100 and a network node 200, for example, gNB. In the example implementations shown, new information is appended to existing messages.

Implementation according to Option A is shown on the left of FIG. 7 and shows a signalling flow according to which a UE is requested to report a calculated predicted UL quality metric to a network node, for example, gNB, and the network node is configured to take the final decision to configure 1 or 2 TA loops in relation to the UE based upon the reported predicted UL quality metric.

Implementation according to option B is shown on the right of FIG. 7 and shows a signalling flow according to which the UE is configured to be directly aware of an UL quality metric threshold. Direct awareness of the threshold which applies in relation to a network node, for example TRP, can enable a UE to compare a calculated predicted UL signal quality metric against the known threshold and make an assessment regarding whether implementation of 1 or 2 TA loops could be beneficial to the operation of the UE in the network. The UE can be configured to report that assessment back to a network node, for example, a gNB.

As shown in FIG. 7, the following signalling steps may be performed:
700A: a UE is configured to indicate to a network, for example using a UE Capability message, that the UE supports UL quality grouping of TCIs.
700B: In response to an awareness of UE capability, a network may be configured to provide the UE with an indication of Downlink Reference Signals (DL RSs) for measurement and reporting for downlink and/or uplink beam selection.

The UE is configured by the network, for example, by a gNB of the network, to perform predicted UL signal quality metric reporting as detailed further below.

### Option A

700C: According to Option A, the UE is configured by the gNB to report back one or more key parameter based upon which the gNB is configured to select whether to use 1 or 2 TA loop in relation to the UE. The configuration message from the network to the UE may, according to some implementations, include an indication of the gNB Sync Point (which is the gNB position within the CP of the first delay). As mentioned previously, that Sync Point can be gNB-implementation specific, and hence not known by UE unless the UE is directly told.

### Option B

700D: According to Option B, the UE is configured by the gNB such that the UE is further provided with UL quality metric threshold parameters, which supports an implementation according to which the UE offers some assistance in relation to assessment of whether a selection of 1 or 2 TA loops is appropriate to support operation of the UE within the network. In the example implementation shown in FIG. 7, the UE configuration parameters comprise thresholds for predicted interference thresholds, for example: P-ISCI and P-SI_{ISCI}R. Again, the configuration signalling may comprise an indication of the gNB UL sync point to assist the UE in the UL quality estimation.

The UE performs predicted UL signal quality metric reporting as detailed further below.

The UE is configured to calculate a prediction of how the TRP estimated UL PDP will look (for example, an estimated UL PDP such as that shown in FIG. 5D). The UE may be configured to calculate, based on an estimated UL PDP, a predicted UL signal quality metric. The predicted UL signal quality metric at a TRP takes into account interference attributable to UL TRP received misalignments due implementation at the UE of a single TA loop. Such a single TA loop can result in delay taps not falling within the CP length at a TRP.

The predicted UL quality metric may comprise and indication of: P-ISCI (predicted Inter Symbol and Carrier Interference); P-SI_{ISCI}R (predicted Signal to Interference and Noise Ratio) or similar. Alternatively, the predicted UL signal quality metric may comprise a predicted delay spread

### Option A

700E: The UE operating according to implementation of Option A is configured to return one or more of the predicted quality measures to the network, to support the gNB in assessing whether the UE is a candidate for using 1 or 2 TA loops.

### Option B

700F: The UE operating according to implementation of Option B is configured with knowledge of one or more UL quality metric thresholds. The UE is configured to compare the calculated predicted UL quality metric against the known threshold. In the event that the calculated predicted UL quality is within (better quality than) the UL quality thresholds configured by gNB, then the UE is configured to assess that use of a single TA loop is sufficient and return an indication of that assessment to the network. Similarly, in the event that the calculated predicted UL quality is outside (worse quality than) the UL quality thresholds configured by gNB, then the UE is configured to assess that use of a single TA loop is insufficient and return an indication of that assessment to the network. For example, if the predicted UL SINR is higher than a configured UL quality threshold for SINR, then the UE will assess that use of a single TA loop is sufficient, and vice-versa.

The UE assessment of step 700E (option A) or 700F (option B) is provided to the gNB using appropriate messaging.

### Option A

700G The UE operating according to implementation of Option A is configured to report via appropriate signaling to the network gNB. That report comprises an indication of one or more of the predicted UL quality metric parameters estimated in step 700E. By way of example, the UE may be configured to report an estimated interference level, for example, the P-SINR or the P-ISCI.

### Option B

700H: The UE operating according to implementation of Option B is configured to report or signal to the network, for example, the gNB, the result of the assessment made by the UE in step 700F. According to some implementations, for each Downlink Reference Signal (DL RS) combination configured as a result of step 700B the UE may be configured to transmit an indication to the network regarding, for each combination, whether a single TA loop is sufficient or whether an additional TA loop could support more efficient network operation. The UE in accordance with some arrangements is configured to assess each combination depending on the appropriate configured UL quality thresholds for each combination.
700J: Arrangements may provide that a the gNB can configure a UE to operate using a second TA loop if it is determined that such a configuration is desirable to network operation. That determination may be based, depending upon implementation, on (i) the explicit value of predicted UL signal quality metric returned to the gNB in step 700G (Option A), or on (ii) the implicit indication of a predicted UL signal quality metric returned to the gNB in step 700H based on a comparison of the explicit value of predicted UL signal quality metric against a threshold (Option B).

In order to support the methodologies illustrated in FIG. 7, arrangements provide a mechanism for a UE to indicate to a network whether it supports UL quality reporting (FIG. 7 step 700A). Such an indication may be provided by a UE in various ways. One implementation provides for adding a parameter to an existing UE-NR-Capability information element. Such an information element is a message sent by the UE to the network, for example, gNB, when requested. The message typically contains a number of parameters describing the capability of the UE.

As one example, a new parameter is added to the existing IE could have the form:

| | |
|---|---|
| { | |
| mTRP-UL-Quality-Grouping | ENUMERATED {supported} |
| } | |

Such an implementation would mean a flag (Boolean) could be included in the information element to indicate that the UE supports the new feature: mTRP-UL-Quality-Grouping. Such IE may be added into UE capability reporting as specified in IE UE-NR-Capability. It will be appreciated that this definition is an example and other names and datatypes could be specified.

In order to support the methodologies illustrated in FIG. 7, arrangements provide appropriate signalling from a network to configure the UE to report a predicted UL signal quality metric (FIG. 7, steps 700C and 700D). That signalling configures a capable UE to either:
(i) report one or more predicted UL signal quality parameter to the network (as in Option A of FIG. 7), or
(ii) use a configured UL signal quality parameter to make an assessment of whether it appears 1 or 2 TA loop is more efficient (as in Option B of FIG. 7)

In support of Option A of FIG. 7, Information Element (IE) sent from gNB to UE may comprise, one, a combination, or all of the parameters shown below:

| RequestPredictedULParameters ::= SEQUENCE { | | |
|---|---|---|
| report-P-SIISCIR | ENUMERATED {true} | OPTIONAL, |
| report-P-ISCI | ENUMERATED {true} | OPTIONAL, |
| report-P-DSmean | ENUMERATED {true} | OPTIONAL, |
| report-P-DSrms | ENUMERATED {true} | OPTIONAL |
| } | | |

By sending such an Information Element to the UE the gNB can configure the UE to estimate and report back any one, or multiple of, the different predictive UL signal quality estimations. For example, according to some arrangements, a network node, for example, gNB, can request that a UE estimate the P-ISCI and report it back to the gNB, or do the same each parameter relevant to predicted uplink signal quality.

In support of Option B shown in FIG. 7, messaging from the network to the capable UE may comprise an indication of one or more condition to assist in determining whether a UE is a candidate for use of a single Timing Advance loop.

For example, in a message “RequiredFor1TAPredictedULParameters” a gNB may indicate one, or multiple, requested UL quality parameters, that must be fulfilled by the corresponding UE estimated predicted UL quality in order for the UE to “select” or suggest a preference for, operation using a single TA loop. If any of the requested parameters are not fulfilled, then the UE must “select” or suggest a preference for, operation using 2 TA loops for mTRP transmission. For example, an Information Element (IE) for indicating the required range for a UE using a single TA loop may be communicated to UE using messaging as follows:

| RequiredFor1TAPredictedULParameters ::= SEQUENCE { | | |
|---|---|---|
| Requested-P-SIISCIR | P-SIISCIR-Range | OPTIONAL, |
| Requested-P-ISCI | P-ISCI-Range OPTIONAL, | |
| Requested-P-DSmean | P-DSmean-Range | OPTIONAL, |
| Requested-P-DSrms | P-DSrms-Range | OPTIONAL |
| } | | |

In order to support the methodologies illustrated in FIG. 7, arrangements provide appropriate signalling from a UE to report a predicted UL signal quality metric back to the gNB. The UE, for example, may be configured to report the UE predicted UL quality parameters (FIG. 7, step 700G). The parameters reported may be those requested in step 700C in message “RequestPredictedULParameters”.

The Information Element (IE) for UE UL quality reporting could, for example, be defined as:

| ReportPredictedULParameters ::= | SEQUENCE { | |
|---|---|---|
| P-SIISCIR | P-SIISCIR-Range | OPTIONAL, |
| P-ISCI | P-ISCI-Range OPTIONAL, | |
| P-DSmean | P-DSmean-Range | OPTIONAL, |
| P-DSrms | P-DSrms-Range | OPTIONAL |

}

Where each of the predicted UL quality metrics can be optionally included in the IE reported to the network. According to arrangements, a report can be sent to the network, for example, gNB, and can be used by the gNB to assess whether, for example, 1 or 2 TA loops are appropriate for use with a certain mTRP combination.

As an example of the definition of the ranges for the different UL quality parameters, the P-SI_{ISCI}R-Range could inherit, or mirror, for example, definition for SINR (from 38.331 3GPP) as shown below:

| | |
|---|---|
| -- ASN1START | |
| -- TAG-SINR-RANGE-START | |
| SINR-RANGE ::= | INTEGER (0..127) |
| -- TAG-SINR-RANGE-STOP | |
| -- ASN1STOP | |

where the range is further described in 38.133 as shown in the table below with the mapping to values in dB.

TABLE 10.1.16.1-1
SS-SINR and CSI-SINR measurement report mapping

| | Measured quantity | Measured quantity | |
|---|---|---|---|
| | value (L3 SS-SINR and | value (L1 SS-SINR and | |
| Reported value | L3 CSI-SINR) | L1 CSI-SINR) | Unit |
| SINR_0 | SINR < −23 | SINR < −23 | dB |
| SINR_1 | −23 ≤ SINR < −22.5 | −23 ≤ SINR < −22.5 | dB |
| SINR_2 | −22.5 ≤ SINR < −22 | −22.5 ≤ SINR < −22 | dB |
| SINR_3 | −22 ≤ SINR < −21.5 | −22 ≤ SINR < −21.5 | dB |
| SINR_4 | −21.5 ≤ SINR < −21 | −21.5 ≤ SINR < −21 | dB |
| . . . | . . . | . . . | . . . |
| SINR_123 | 38 ≤ SINR < 38.5 | 38 ≤ SINR < 38.5 | dB |
| SINR_124 | 38.5 ≤ SINR < 39 | 38.5 ≤ SINR < 39 | dB |
| SINR_125 | 39 ≤ SINR < 39.5 | 39 ≤ SINR < 39.5 | dB |
| SINR_126 | 39.5 ≤ SINR < 40 | 39.5 ≤ SINR < 40 | dB |
| SINR_127 | 40 ≤ SINR | 40 ≤ SINR | dB |

FIG. 8 illustrates schematically some components of a network including nodes according to some arrangements; and FIG. 9 illustrates schematically steps of methods performed in accordance with some arrangements.

FIG. 8 illustrates schematically some components of a network including nodes according to some arrangements. The network 1000 comprises a plurality of TRPS 1200A, 1200B in communication with user equipment 1200.

The user equipment 1100 takes the form of an n apparatus, comprising:
means for indicating 1110, to another node 1200A, that a plurality of timing advance loops are supported;
means for receiving 1120, from the another node 1200A, a configuration for measuring received reference signals from the another node 1200A, 1200B;
means for performing measurements 1130 on the received reference signals according to the configuration;
means for evaluating 1140, based on the measurements, an indication of a predicted signal quality metric in relation to at least one of: the another node 1200A or a further node 1200B based upon conditional use of at least one timing advance loop; and
means for transmitting 1150 information relating to the evaluated indication of a predicted signal quality metric at the at least one of the another node 1200 and further node 1200B.

The network node 1200A takes the form of an apparatus, comprising:
means for determining 1210 that a plurality of timing advance loops are supported by a node;
means for transmitting 1220, to the node 1100, a configuration for measuring received reference signals;
means for receiving 1230, from the node 1100, information relating to an evaluated indication of a predicted signal quality metric at the least one of another node or a further network node 1200B.

FIG. 9 illustrates schematically steps of methods performed in accordance with some arrangements.

The user equipment 1100 may be configured to perform a method comprising the steps of:
9110: indicating, to another node, that a plurality of timing advance loops are supported;
9120: receiving, from the another node, a configuration for measuring received reference signals from the another node;
9130: performing measurements on the received reference signals according to the configuration;
9140: evaluating, based on the measurements, an indication of a predicted signal quality metric at in relation to at least one of: the another node or further node based upon use of a common timing advance loop; and
9150: transmitting, information relating to the evaluated indication of a predicted signal quality metric at the at least one of the another node and further node.

The network node 1200A may be configured to perform a method comprising the steps of:
9210: determining that a plurality of timing advance loops are supported by a node;
9220: transmitting, to the node, a configuration for measuring received reference signals;
9230: receiving, from the node, information relating to an evaluated indication of a predicted signal quality metric at the least one of another node or a further node.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
at least one processor; and
at least one memory including computer program code, the at least one memory and the computer program code configured to, with the at least one processor, cause the apparatus to indicate, to another node, that a plurality of timing advance loops are supported;
receive, from the another node, a configuration for measuring received reference signals from the another node;
perform measurements on the received reference signals according to the configuration;
evaluate, based on the measurements, an indication of a predicted signal quality metric in relation to at least one of: the another node or a further node based upon conditional use of at least one timing advance loop; and
transmit information relating to the evaluated indication of a predicted signal quality metric in relation to the at least one of the another node or the further node.

2. The apparatus of claim 1, wherein the configuration for measuring received reference signals comprises: an indication of one or more signal quality metric to be evaluated.

3. The apparatus of claim 2, wherein the one or more signal quality metric to be evaluated comprises: an indication of interference, or an indication of signal spread, at the another node or further node as a result of conditional use of the at least one timing advance loop.

4. The apparatus of claim 2, wherein the one or more signal quality metric to be evaluated comprises: an indication of interference caused by timing misalignment caused at the another node or further node based upon conditional use of the at least one timing advance loop.

5. The apparatus of claim 1, wherein the configuration for measuring received reference signals comprises: a threshold predicted quality metric.

6. The apparatus of claim 5, wherein the at least one memory and the computer program code configured to, with the at least one processor, cause the apparatus to:
compare the evaluated indication of predicted signal quality metric at the another node or further node against the threshold predicted quality metric.

7. The apparatus of claim 6, wherein the transmitted information relating to the evaluated indication of a predicted signal quality metric in relation to the at least one of the another node or the further node comprises: an indication of whether the predicted signal quality metric is above or below the threshold.

8. The apparatus of claim 1, wherein the apparatus comprises user equipment, and the another node comprises a network node.

9. The apparatus of claim 1, wherein the further node comprises a network node.

10. The apparatus of claim 1, wherein the another node and further node comprise different physical nodes or a same physical node.

11. The apparatus of claim 1, wherein the received reference signals comprise downlink signals.

12. The apparatus of claim 1, wherein the received reference signals comprise signals received from the at least one of: the another node or the further node.

13. The apparatus of claim 1, wherein the evaluated indication of a predicted signal quality metric comprises: an evaluated indication of a predicted uplink signal quality metric.

14. The apparatus of claim 1, wherein the at least one memory and the computer program code configured to, with the at least one processor, cause the apparatus to:
receive an activation of an additional timing advance loop to be applied in relation to communication with the at least one of the another node or the further node in response to transmitting information relating to the evaluated indication of a predicted signal quality metric in relation to the at least one of the another node or the further node.

15. An apparatus, comprising:
at least one processor; and
at least one memory including computer program code, the at least one memory and the computer program code configured to, with the at least one processor, cause the apparatus to determine that a plurality of timing advance loops are supported by a node;
transmit, to the node, a configuration for measuring received reference signals; and
receive, from the node, information relating to an evaluated indication of a predicted signal quality metric in relation to at least one of: another node or a further node.

16. The apparatus of claim 15, wherein the at least one memory and the computer program code configured to, with the at least one processor, cause the apparatus to:
compare the information relating to the evaluated indication of a predicted signal quality metric in relation to the at least one of the another node or the further node against a threshold predicted quality metric to determine whether to activate an additional timing advance loop.

17. The apparatus of claim 15, wherein the at least one memory and the computer program code configured to, with the at least one processor, cause the apparatus to:
assess the information relating to the evaluated indication of a predicted signal quality metric in relation to the at least one of the another node or the further node to assess whether the threshold predicted quality metric is met.

18. The apparatus of claim 16, wherein the at least one memory and the computer program code configured to, with the at least one processor, cause the apparatus to:
transmit an activation of at least one additional timing advance loop in response to the determination based upon the received evaluated indication of a predicted signal quality metric in relation to the at least one of the another node or the further node.

19. The apparatus of claim 15, wherein the apparatus comprises a network node, and the node comprises user equipment.

20-26. (canceled)

27. A method, comprising:
indicating, to another node, that a plurality of timing advance loops are supported;
receiving, from the another node, a configuration for measuring received reference signals from the another node;
performing measurements on the received reference signals according to the configuration;
evaluating, based on the measurements, an indication of a predicted signal quality metric in relation to at least one of: the another node or further node based upon conditional use of at least one timing advance loop; and
transmitting, information relating to the evaluated indication of a predicted signal quality metric in relation to the at least one of the another node or the further node.

28-44. (canceled)
